(19) United States
(12) Patent Application Publication
(10) Pub. No.: US 2018/0198872 A1
(43) Pub. Date: Jul. 12, 2018

(54) METHOD, SYSTEM AND DEVICE FOR PROVIDING SERVICE

(71) Applicant: Alibaba Group Holding Limited, George Town (KY)

(72) Inventors: Kai Wang, Beijing (CN); Zhijun Yuan, Hangzhou (CN); Xinzheng Li, Hangzhou (CN)

(21) Appl. No.: 15/864,245

(22) Filed: Jan. 8, 2018

(30) Foreign Application Priority Data
Jan. 9, 2017 (CN) 201710013460.1

(51) Int. Cl. H04L 29/08; G06F 17/30

(52) U.S. Cl. CPC H04L 67/16; G06F 17/30424

(57) ABSTRACT

Providing services includes: monitoring one or more signals that are generated by a device or received at the device; determining a service agent based on at least one monitored signal, wherein the service agent corresponds to an application and is configured to detect and execute one or more services associated with the application; determining service instruction information corresponding to the determined service agent; and executing one or more operations corresponding to the determined service instruction information.

### CROSS REFERENCE TO OTHER APPLICATIONS

This application claims priority to People's Republic of China Patent Application No. 201710013460.1 entitled A METHOD, MEANS, TERMINAL DEVICE AND OPERATING SYSTEM FOR PROVIDING SERVICES, filed Jan. 9, 2017 which is incorporated herein by reference for all purposes.

### FIELD OF THE INVENTION

The present application generally relates to the field of terminal device technology and more particularly, to a system, method and device for providing services, as well as an Internet of Things (IoT) operating system for providing services.

### BACKGROUND OF THE INVENTION

With the terminal device technology developing to encompass an increasing number of device types, for example, screen-based devices, screenless devices, wearable devices and household devices, more and more people have become users of such terminal devices, and more and more functionalities and services have become available at such terminal devices. Presently, services provided at terminal devices generally are in the form of applications (also referred to as apps), with the interface for accessing the services generally configured at a home screen or a desktop of the terminal device.

In general, different services are provided through different applications that specialize in servicing a particular type of user needs. For instance, a chat service is provided by instant messaging apps, and an on-line shopping service is provided by e-commerce apps. An application needs to be in a state of execution in order to provide services. For example, even without displaying a user interface to a user, an application still needs to execute in the background in order to receive and process data for the purpose of providing services to the user. Therefore, in providing services to users, a terminal device often executes a multitude of processes in the background as well as in the foreground, and becomes in an overloaded state that consumes a large amount of system resources. Consequently, the processing speed of the processes slows down, and the system can run out of power quickly. Existing resource conservation measures typically rely on shutting down idle processes. However, when processes are shut down, the terminal device can no longer receive the most up-to-date information or present such information, thus limiting the capabilities of the applications and negatively impacting the user experience.

Therefore, there exists a need for providing services through applications on terminal devices in a system resource efficient manner.

### BRIEF DESCRIPTION OF THE DRAWINGS

Various embodiments of the invention are disclosed in the following detailed description and the accompanying drawings.

FIG. 1 is a schematic diagram illustrating an example context-aware providing service, in accordance with one or more embodiments of the present disclosure.

FIG. 2 is a flowchart illustrating an example process for context-aware providing service, in accordance with one or more embodiments of the present disclosure.

FIG. 3A is a flowchart illustrating another example process for providing context-aware services in accordance with one or more embodiments of the present disclosure.

FIG. 3B is a flow chart illustrating another example process for providing context-aware services, in accordance with one or more embodiments of the present disclosure.

FIG. 4A is a schematic diagram illustrating an example service providing system, in accordance with one or more embodiments of the present disclosure.

FIG. 4B is a block diagram illustrating an example system model for providing services, in accordance with one or more embodiments of the present disclosure.

FIG. 5A is a relational diagram illustrating components of an example system model for providing services, in accordance with one or more embodiments of the present disclosure.

FIG. 5B is a schematic diagram illustrating an example service providing application developed according to system model 450 of FIG. 4B, in accordance with one or more embodiments of the present disclosure.

FIG. 5C is a schematic diagram illustrating various components of an example Context Agent Framework of System 450 of FIG. 4B, in accordance with one or more embodiments of the present disclosure.

FIG. 5D is a schematic diagram illustrating an example life cycle of an example service providing application, in accordance with one or more embodiments of the present disclosure.

FIG. 5E is a schematic diagram illustrating example state transitions controlled by Context Agent Engine 456 of FIG. 4B, in accordance with one or more embodiments of the present disclosure.

FIG. 5F is a functional block diagram illustrating an example interaction between Pages, in accordance with one or more embodiments of the present disclosure.

FIG. 5G is a schematic diagram illustrating an example state transitioning of a Page, in accordance with one or more embodiments of the present disclosure.

FIG. 5H is a schematic diagram illustrating another example state transitioning of a service component, in accordance with one or more embodiments of the present disclosure.

FIG. 6 is a functional diagram illustrating an embodiment of a terminal device for providing services, in accordance with one or more embodiments of the present disclosure.

FIG. 7 is a functional diagram illustrating an embodiment of a programmed computer system for providing services, in accordance with one or more embodiments of the present disclosure.

FIG. 8 is a block diagram illustrating an example operating system for providing services, in accordance with one or more embodiments of the present disclosure.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The term “terminal device” as used herein refers to a computing device enabled with applications such as multimedia functionalities and services. Examples of a terminal device include a smart phone, a tablet, a wearable device, a set-top box, a personal computer, a smart television, a smart household appliance, a desktop computer, a laptop computer, an in-vehicle computer, an Internet of Things (IoT) object, or the like. A terminal device can be configured to provide services of audio, video, data, etc. to a user.

The terms “component,” “service,” “model,” “applications,” and “system” as used herein refer to a computer-related entity, either hardware, a combination of hardware and software, software, or software in execution. For example, a component may be, but is not limited to, a process running on a processor, an object, an executable, a thread of execution, a program, and/or a computer. One or more components may reside within a process and/or thread of execution and a component may be localized on one computer and/or distributed between two or more computers.

The term “Internet of Things” (IoT) as used herein refers to the technology implementing the architecture that a large number of objects, not limited to computers or computer networks, can be readable, recognizable, locatable, and controllable via a network (e.g., the Internet). Example objects of an IoT network can include a variety of information-gathering devices such as RFID equipped devices, infrared sensor equipped devices, global positioning systems (GPS) equipped devices, laser scanner equipped devices, and the like. In the age of ubiquitous connectivity of things, terminal devices of users are becoming increasingly diverse to include devices with screens, devices without screens, household devices, wearable devices, and the like.

According to various embodiments of the present disclosure, a system is configured to directly monitor signals, based on which at least one service agent and its corresponding service instruction information is determined. While the determined service agent corresponds to an application, the operations corresponding to the service instruction information are executed accordingly. Using the service agent transmitted by the application, the system performs logic processing upon the signals and executes corresponding operations. Thus, unnecessary to transmit the detected signals to the application for logic processing and handling, the system is no longer required to keep processes servicing the application in the execution state, achieving decreased consumption of system resources such as power at the terminal device.

In some embodiments, an application is configured with one or more corresponding service agents (also referred to as context agents). Service agents are configured to detect service contexts and to execute logic operations based on the detected contexts. As used herein, a service context refers to one or more conditions or states under which a service and/or its associated operations are invoked. Once tied to a particular device and/or execution environment, a service agent is an instantiated service agent instance, also referred to as an executing entity of a service agent for the application. With this configuration, the application in turn detects and processes contexts via the service agent. In other words, the application, with a background service in the system to monitor signals, detects contexts and performs logic processing of the contexts via the service agent.

In one example, developers built a context-aware application configured to play a playlist if it is detected that the earphones are plugged in to a user's terminal device and the user is currently running or walking. Here, the developer further built a service agent using the Javascript language as follows:

```
“use strict”;
const ConditionAgent = require(“yunos/contextagent/ConditionAgent”);
let agent = ConditionAgent.define(
  “headphone”,
  “agent://contextagent.yunos.com/agentdemo”,
  (template) => {
    let stream1 = ConditionAgent.getStream(“signal://yunos.com/
    headsetplug”);
    let stream2 = ConditionAgent.getStream(“signal://yunos.com/
    personalactivity”);
    return stream1.on(“state”, Condition.EQ, “plugged-in”)
      .and(
        stream2.on(“state”, Condition.EQ, “running”)
        .or(stream2.on(“state”, Condition.EQ, “walking”))
      )
      .subscribe([{
        actuator: “actuator://yunos.com/musiccard”,
        action: “action://yunos.com/showcard”,
        params: “page://xiami.com/favoritemusic”
      }]);
  }
);
module.exports = agent;
```

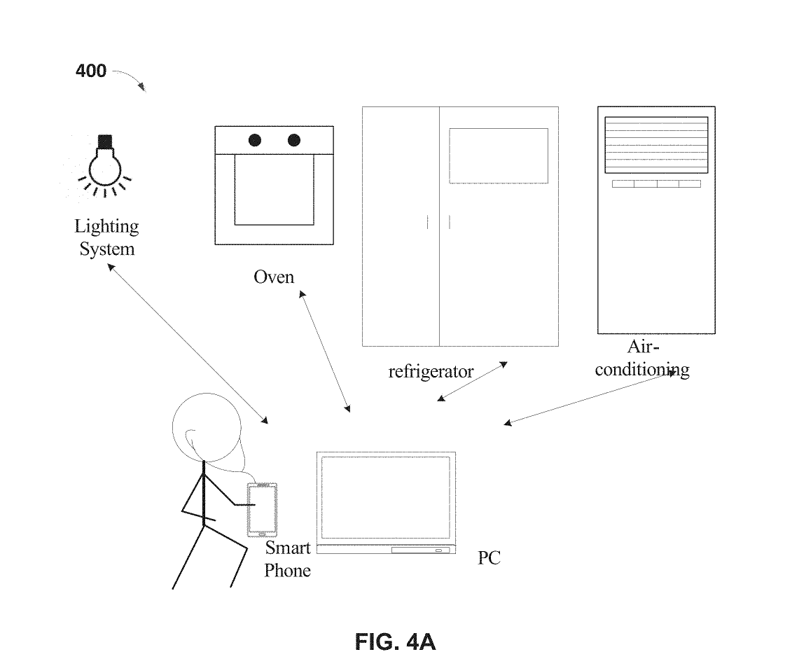

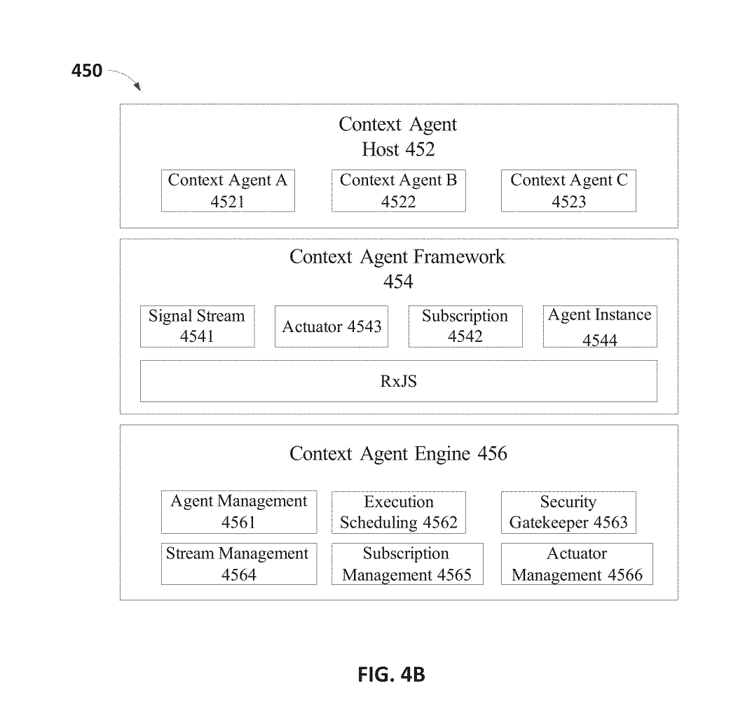

As shown in the above script, the service agent (“agent”) is defined based on a template specified in a programming model (details of which are described with reference to FIG. 4B) to capture the basics of this app as to: detect the signals from stream 1 (headsetplug) and stream 2 (personalactivity), set the triggering context as “plugged-in” and (“running” or “walking”), and to provide the service of using the “actuator” to perform the “action” with the “params” applied.

In various embodiments, service instruction information is configured to determine the processing logic of a context which an application is configured to handle. In some embodiments, one context corresponds to one operation or functionality of the service provided by the application. Accordingly, service instruction information can be used to represent the processing logic corresponding to the operation of the service provided by the application. On the other hand, a service agent, configured with the information such as the signals required (e.g., triggering signals), the afore-described service instruction information, and the corresponding service conditions, etc., executes the corresponding processing logic based on the signals.

As used herein, the term “signal” refers to an entity (such as an object) that carries data at a device. Signals can include, for example, data generated by the device, data received at a device, or the like. Device data encompasses, for example, software data, hardware data, and firmware data generated by a device, including for example, inter-software communication command data, signals obtained from sensors, microphones, or other I/O interfaces. Data received at a device encompasses, for example, instruction data, command data, hardware data, and interface data received at a device from another device, system, or network. For example, when a device receives a signal, in the form of interface data, that indicates that earphones have been plugged into the device and the device can launch a media-playing app to play a playlist of songs or other audio data. For another example, when a device detects external Bluetooth signals, it connects the corresponding Bluetooth earphones or other Bluetooth devices or Bluetooth signal dependent services with the external Bluetooth signals. For yet another example, when a device detects signals of temperature data from a weather app, it causes an air-conditioning system configured to respond to the temperature data to be turned on. With the ability to obtain, detect, or receive various data at a device such as to trigger corresponding context-aware apps, various services are provided to a user.

According to various embodiments of the present disclosure, a signal can be generated by or received at a signal source. A signal source obtains signals in various manners, for example, via passive triggering (e.g., without a user's active initiation to obtain signals) or active triggering (e.g., with a user's active initiation to obtain signals). With regard to passive triggering, a signal source obtains signals from, for example, an external device, a sensor, various device internal or related information data such as broadcast information, app information, or notification information, and device status information generated based on device statuses, without active participation by the user. With regard to active triggering, a signal source obtains signals upon a user's operation that triggers a signal to be generated or received. For example, when a user scans a QR code, a device acquires a QR code signal, which corresponds to a particular service. For another example, a user's active initiation of triggering to obtain signals from a signal source can be a user clicking to share a link or launch a widget related to a service agent, or a user selecting a signal from a set of signals provided. With the ability to obtain various signals from various signal sources, services corresponding to obtained signals can be provided to users accordingly.

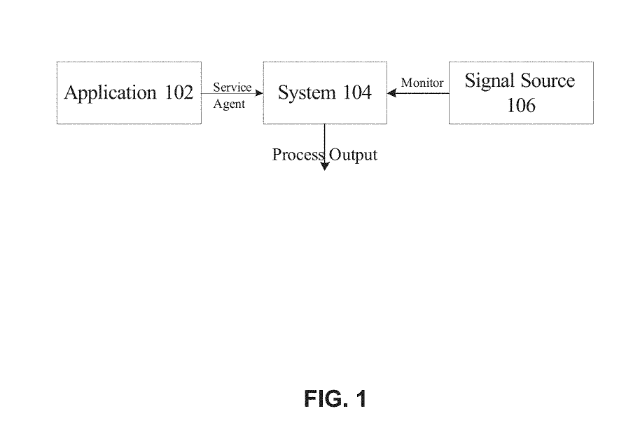

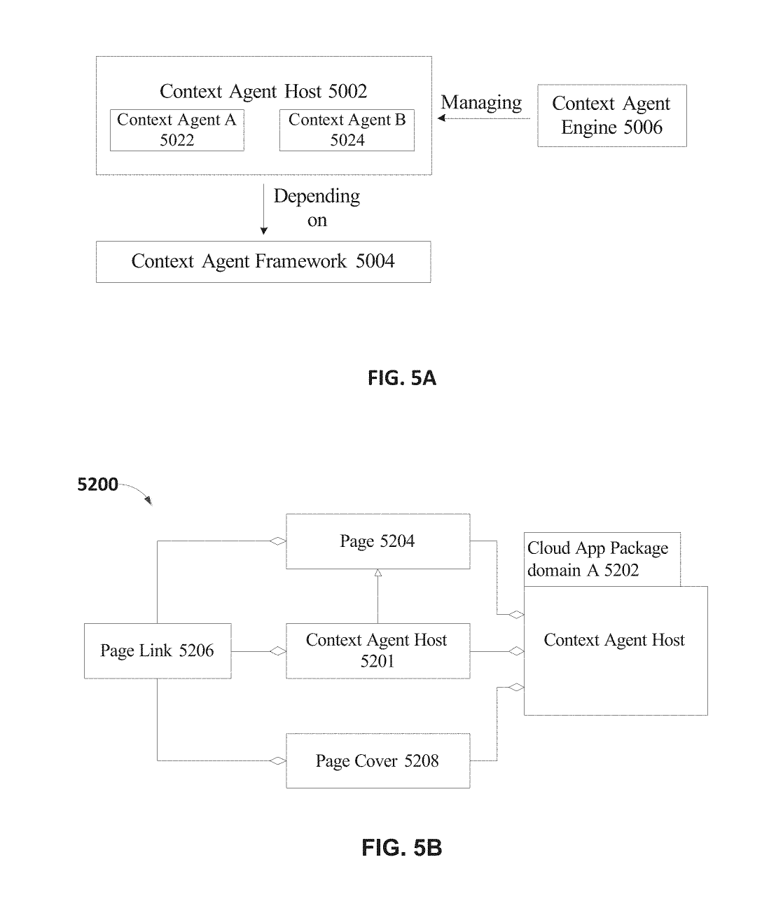

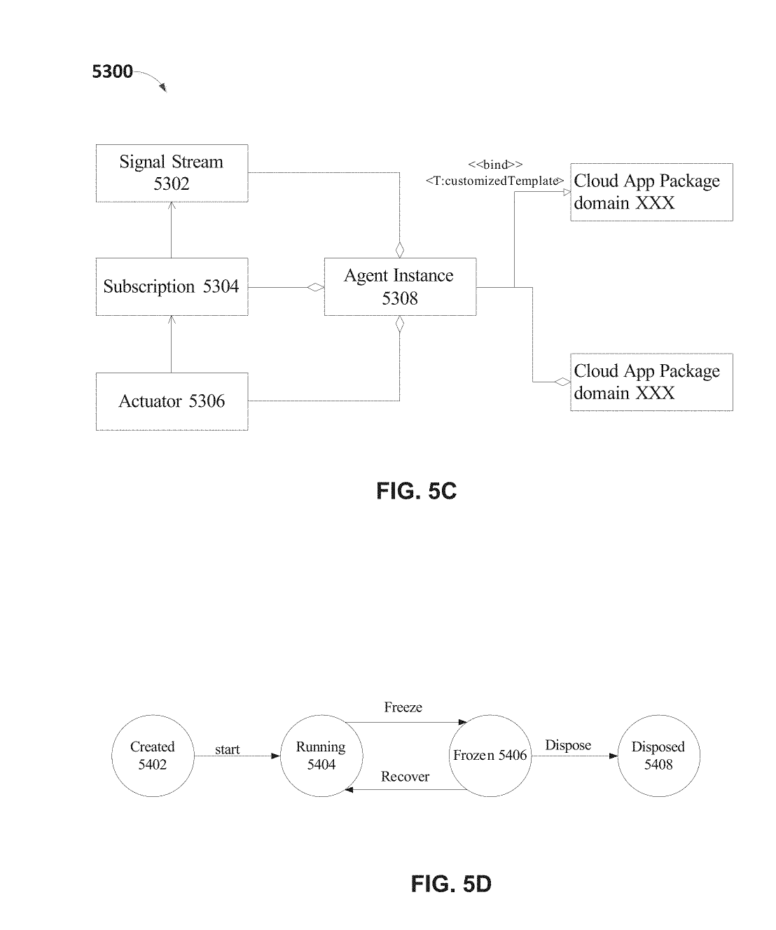

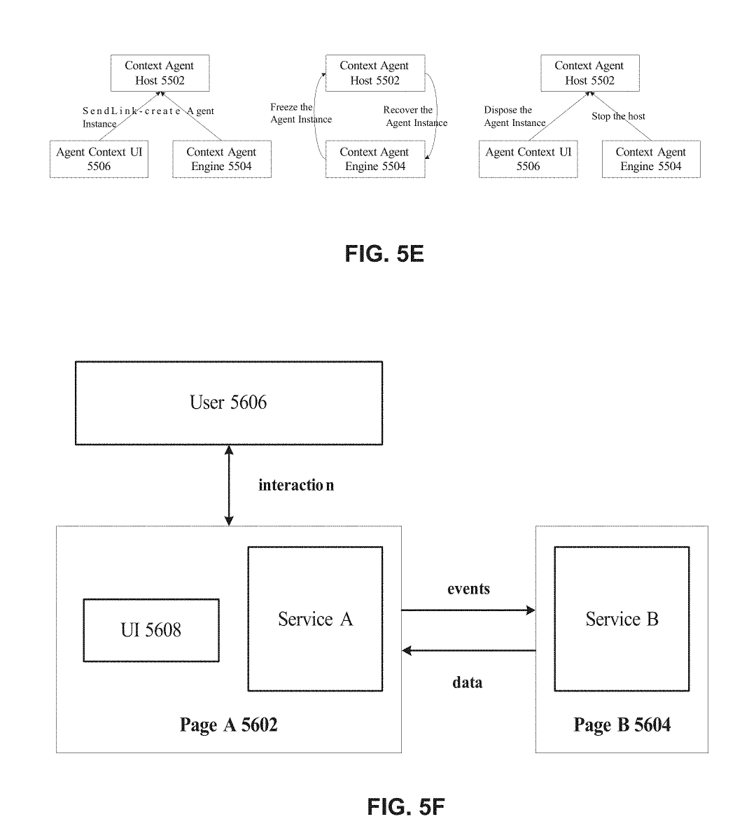

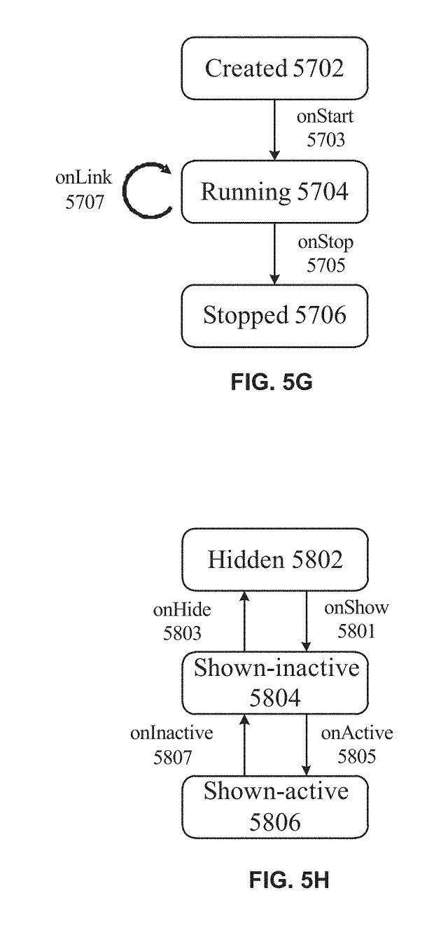

FIG. 1 illustrates a block diagram of an example system for providing context-aware service, in accordance with an embodiment of the present disclosure. In this example, application 102 executes on system 104; and system 104 can be configured to monitor signal source 106 to obtain signals. To decrease the amount of consumption of system resources such as power on a device, an application service agent of an application 102 is transmitted to a system 104 (e.g., an operating system) such that system 104 can detect contexts and process the detected contexts on behalf of application 102 by using the service agent. In particular, a service agent is implemented using the Javascript language and can be executed independently from its respective application. In some embodiments, a service agent can be implemented in the form of Agent inheriting from Context Agent Framework the functionalities to monitor (e.g., streams of signals) and to execute operations (e.g., by use of actuators). An executing entity of Agent is an instantiated agent tied to a particular environment and device. Further details of Agent, Agent Instance, and Context Agent Framework are described with reference to FIGS. 4B, 5A and 5C. Each application can be configured to correspond to one or more service agents, and an operating system can be configured to receive and host a multitude of service agents, which can be the agents for one or more services. Service agents are configured to detect and to execute the service operations of an application. In other words, a service agent is configured to detect the triggering of the corresponding service or to detect the activation of the corresponding service, and consequently execute the corresponding server operations.

System 104 determines which signals to monitor based on the transmitted service agent and starts monitoring one or more signal sources 106 to obtain the determined signals. For example, by use of a table or file or database mapping relationships between service agents and signals, one or more service agents can be determined. More details are described below. When system 104 detects at least one signal, it uses the signal to look up a service agent that matches the signal detected. For example, the system receives a service agent X and a service agent Y. Next, the system determines to monitor for signal A and signal B, based on the subscription information which records subscription relationships indicating that service agent X subscribes to signal A, and service agent Y subscribes to signal B. Afterwards, the system detects signal A and looks up the service agent corresponding to signal A (in this case, service agent X) for further operations. Subsequently, system 104 further determines whether the service agent's service conditions have been met, and determines the service instruction information corresponding to the service agent whose service conditions have been met. Next, system 104 executes the service operations corresponding to the determined service instruction information. Thus, upon detecting a signal, system 104 determines a context directly by using the service agent and processes the detected context without running the application corresponding to the service in the system. Details of the context aware processing are described below. This way, the consumption of system resources is decreased so that resources such as power are preserved without affecting the capability to provide services at a device.

According to various embodiments of the present disclosure, a service agent is configured with configuration information pertaining to signals required for the service, service conditions, service instruction information, etc. A service agent dictates the detecting and processing of a certain context. One service agent can correspond to one or more contexts, with different contexts or the combinations thereof triggering different context-based services. One context is configured to correspond to a set of one or more signals, service conditions, and service instruction information.

Signals associated with a context are the signals required by the context services. Service conditions associated with a context are conditions defined by the context, used to determine whether a particular context can be considered as the triggered context, e.g., a context that is detected as occurring and thereby able to trigger the corresponding services under the occurrence of the context. Service conditions can include, for example, a combination of conditions based on the value of various signals. Service instruction instructs the service(s) corresponding to the context to perform certain operations. Service instruction information can include, for example, logic processing and other instructive information (e.g., outputting data with or without processing). Take for example a context-aware service of playing music listed in a playlist upon detecting that earphones are plugged in and a user is currently walking or running, the required signals for the context are: signal A of the terminal device connecting to the earphones, signal B of the user currently walking, and signal C of the user currently running. The service instruction is to play the playlist, and the service condition is A and B, or A and C. Thus, upon detecting signals A and B or signals A and C, the device plays the playlist to the user.

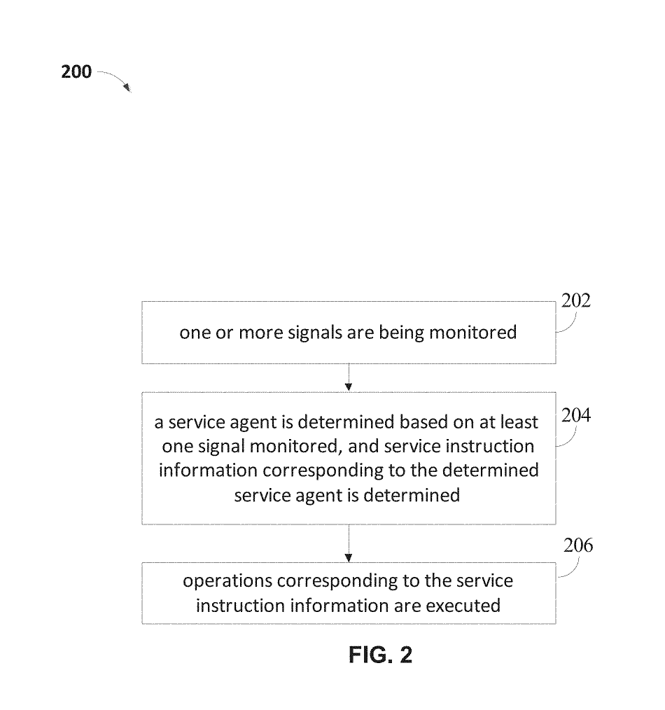

FIG. 2 illustrates a flowchart of an example process for providing context-aware service, in accordance with an embodiment of the present disclosure. In this example, process 200 can be implemented at a system, for example, system 104 of FIG. 1. Process 200 can also be implemented at an operating system.

Process 200 starts at 202 where one or more signals are being monitored. As described above, process 200 can start to monitor one or more signal sources such as a sensor, a network card, or an app, by using the communication protocols configured for the system.

At 204, a service agent is determined based on at least one signal monitored, and the service instruction information corresponding to the determined service agent is determined based on the determined service agent. As described in more details below, a service agent can be looked up by using a database registering mapping or corresponding relationships between signals and service agents.

At 206, operations corresponding to the service instruction information are executed. Once the service agent is determined, the configuration information associated with the service agent is obtained. As described above, using the service instruction information associated with the service agent, operations corresponding to the service instruction information can be determined and thereby executed.

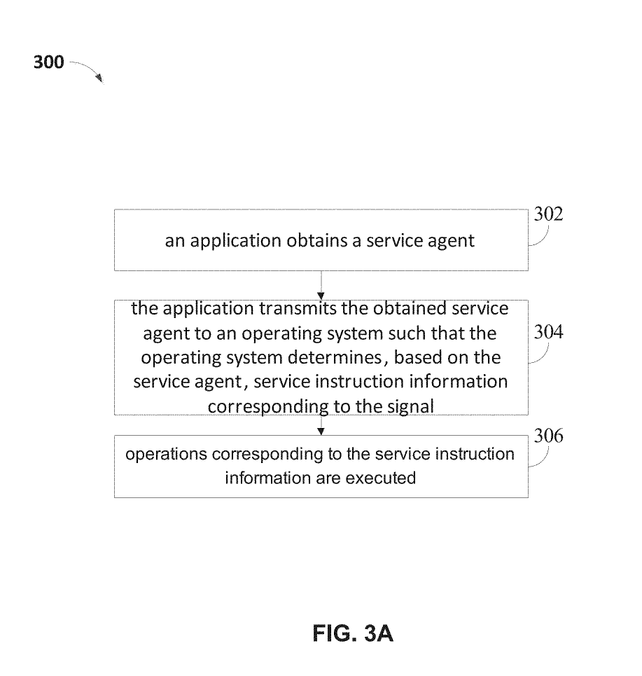

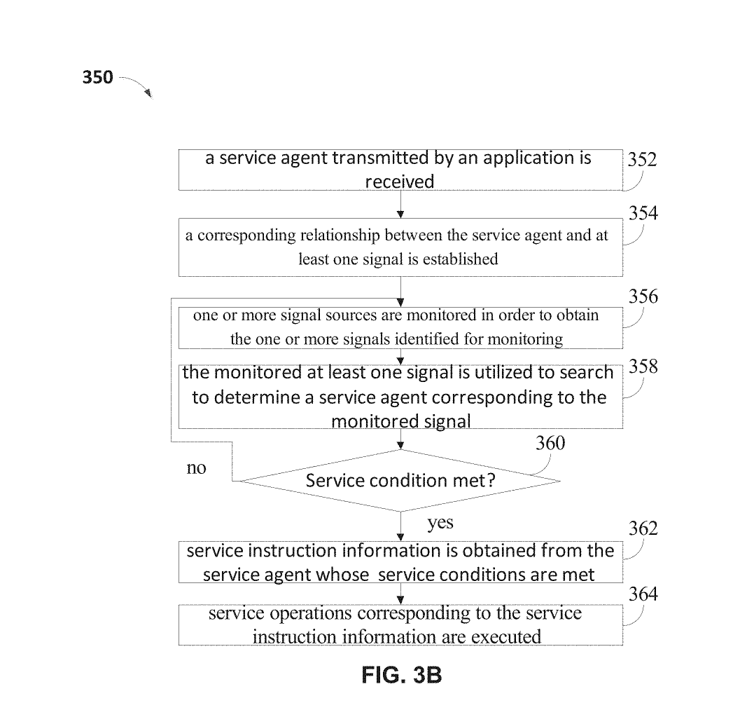

FIG. 3A illustrates a flowchart of an example process for providing context-aware service, in accordance with an embodiment of the present disclosure. In this example, process 300 can be implemented at an application, for example, by application 102 of FIG. 1.

Process 300 starts at 302 where an application obtains a service agent. Further details are described with reference to FIGS. 4B, 5B-5C below.

At 304, the application transmits the obtained service agent to an operating system such that the operating system determines, based on the service agent, the service instruction information corresponding to the signal. For example, an application can invoke an RxJS command “export” to transmit a service agent coded in Javascript to the operating system.

At 306, the operations corresponding to the service instruction information are executed.

After an application is installed onto a terminal device's operating system, the application is configured with a service agent. It is through the service agent that the application detects service contexts and provides the services under the context. In order to decrease the consumption of system resources, the application can instead obtain the service agent and transmits the service agent to the operating system so that the operating system can provide services based on the service agent, on behalf of the application. In other words, the operating system determines the service instruction information corresponding to signals based on the service agent and executes the operations corresponding to the service instruction information.

In some embodiments, each application corresponds to one or more service agents. A service agent is configured to detect the triggering of and execute service operations provided by the application. A service agent is configured to comprise, for example, information pertaining to one or more signals, service instruction information, and service conditions, etc. Upon receiving the one or more signals and determining that the service conditions are met, the service agent executes the operations corresponding to the service instruction information. Service instruction information is configured to comprise, for example, service identifying information and service operation information. Service identifying information is used to determine data to be acquired for the service; and service operation information is used to determine operations to be executed in order to provide the service. In some embodiments, service instruction information is configured to further comprise, for example, service parameters, which are used to determine data to be applied in order to provide the service.

In this example, after obtaining one or more service agents from respective applications, the operating system uses the service agents to determine the signals to be monitored. As a result, the operating system monitors signals that are either received or generated at a terminal device. For signals received by a terminal device, the received signals can be obtained through monitoring interfaces at which such signals are received. For signals generated at a terminal device, a signal source can be monitored to obtain the signals generated by the signal source. In an implementation, an interface can be treated as a signal source, which is monitored by the operating system to obtain signals received thereat.

The operating system can detect one or more signals by monitoring interfaces configured to receive the one or more signals. The detected one or more signals are then used to search for corresponding service agents. Once the service agents are determined (details of which are described below with reference to FIG. 3B), the operating system further determines which service agents have their respective context-based service triggering conditions met. The application corresponding to the service agent having triggered service conditions is the context-aware service to be provided to process the context. Next, the operating system obtains the service instruction information corresponding to the service agent whose service conditions are met, and executes the service operations (e.g., playing music or controlling an IoT device to turn an air-conditioning system on or off, to turn lights on or off, etc.) corresponding to the service instruction information. As a result, the operating system is configured to automatically detect application contexts and to execute operations triggered by the contexts.

In some embodiments, the aforementioned system or operating system can involve an IoT system. For example, upon detecting a context, a mobile phone operating system can be configured to control an IoT system to execute corresponding operations according to the detected context. For another example, upon detecting a context, the operating system of an in-vehicle device can be configured to control the cruising of the vehicle according to the detected context. Therefore, monitored signals by a system can comprise various signals received from IoT devices, the contexts corresponding to the monitored signals are subsequently determined, and operations corresponding to the context are executed accordingly. For example, signals from a lighting system on a household network, signals from a security system, and signals from various smart household appliances including smart kitchen appliances can all be transmitted through corresponding interfaces to a mobile terminal device such as a smart phone. The operating system of the smart phone can be configured to monitor the corresponding interfaces to obtain the signals. The operating system determines a context corresponding to the obtained signal by determining a service agent whose service conditions are met. Then, the operating system executes the service operations corresponding to the service instruction information of the service agent, realizing the operation system achieving context detection and processing by using one or more service agents of an app at the terminal device. This way, the usage of system resources such as power is decreased because, with the system taking over the triggering and operations of the services provided by the app, the app no longer needs to be the execution state for rendering the corresponding services available.

FIG. 3B illustrates a flowchart of another example process for providing services, in accordance with an embodiment of the present disclosure. Process 350 can be implemented by, for example, system 104 of FIG. 1.

Process 350 starts at 352 where a service agent transmitted by an application is received. For example, in the case where a service agent is programmed in the Javascript language, the respective application can invoke commands such as “export” to forward the service agent in the form of Javascript code to the system.

At 354, the corresponding relationship between the service agent and at least one signal is established.

In this example, a programming model is provided to develop context-based services such that the services based on contexts can be handled in a systematic or unified manner. With such a model, services to be provided based on a context can be adequately dictated through a service agent. For example, for a context-aware service developed using the programming language of JavaScript, a programming model can employ codes in JavaScript to indicate how a context is to be serviced.

In this example, after an application is installed onto the system of a terminal device, in order to provide context-aware services to the user of the terminal device without consuming a large amount of system resources, the application is configured to transmit a service agent for servicing the context to the system. The service agent is executed by the system such that, even when the application is not in a running state, the execution of the context-based service continues and is not affected by the execution state of the application. Since various applications can be installed on a terminal device to provide for various context-aware services, in this example, corresponding relationships are established between service agents and at least one or more signals in order to determine signals to be monitored and to identify service agents corresponding to the monitored signals. In other words, corresponding relationships between service agents and signals to be monitored are recorded, using a mapping table, a configuration file, or any other appropriate database.

In various embodiments of the present disclosure, a system detects a context and executes the handling of the detected context using a background service agent corresponding to an application. In this example, a background service of the system is configured to comprise components of an Agent Engine, a Signal Provider, and an Actuator Provider Agent Engine is configured to receive service agents from applications; Signal Provider is configured to monitor and obtain signals; and Actuator Provider is configured to provide services corresponding to the contexts.

In some embodiments, the establishing of a corresponding relationship between a service agent and at least one signal includes: obtaining from the service agent a signal required for executing the service agent, and recording the corresponding relationship between the service agent and the signal. In other words, Agent Engine is configured to obtain signals required for servicing a context from a service agent, and to record this obtained signal as the signal to be monitored. In some embodiments, Context Agent Engine utilizes Subscription Management 4565 of FIG. 4B to consult a stored relationships table or file or database that maps the context-based service agent to the signals the context-based service agent subscribes to. Then, Agent Engine is further configured to log the corresponding relationship between the required signal and the service agent in, for example, a table or a configuration file, registering the relationships between services and signals. Thus, the operating system maintains such a table or configuration file capturing the relationships between service agents and signals, the service agents and the signals forming one to one, one to many, or many to many relationships. Thus, after receiving a new service agent, the system adds an entry to the table or configuration file to record the corresponding relationship between the newly received service agent and the identified signals required therefor.

At 356, one or more signal sources are monitored in order to obtain the one or more signals identified for monitoring.

In this example, an operating system is configured to use the above-described Signal Provider to monitor signal sources corresponding to the one or more signals identified. Such signal sources can be, for example, a signal source that generates signals or a signal source that receives signals at an interface of the terminal device. Upon detecting either signals generated at a source or signals received at a source, the background service is executed to obtain the signals detected.

Again, taking the context-aware application of playing a playlist when the user has plugged the earphones into a device and is either walking or running for example, through the service agent it is determined that two signal sources corresponding to the status of the earphones (plugged in or not) and the motion status of the user (moving at a speed within a first range (walking) or within a second range (running)) are to be monitored. In implementation, the signal of the status of the earphones can be obtained from, for example, the interface for connecting the earphones. And the signal of the user motion status can be obtained from, for example, a sensor such as a pedometer, an accelerometer, a global positioning system (GPS), or the like. Once the signal sources are determined, the system monitors these two signal sources on behalf of the context-aware application. When obtained from either or both of these two signal sources, signals are transmitted to the system background service. As a result, the context-aware application of playing a playlist is triggered automatically by the signals detected, without requiring separate, manual launching of the playlist. In this manner, even when the context-aware application is no longer running, the monitoring of the signal sources is not to be affected for the purposes of providing service.

In some embodiments, the monitoring of signals comprises monitoring signals using a monitor strategy. In other words, signal sources are monitored according to a monitor strategy to obtain signals. A monitor strategy is, for example, a strategy configured to monitor signals with different monitor actions suitable under different states of a system.

The monitoring of signals based on monitor strategies includes at least one of the following: selecting a signal, based on a monitor strategy and a signal priority level, for monitoring; or adjusting a monitoring frequency, based on a monitor strategy, for monitoring signals based on the adjusted monitoring frequency.

In some embodiments, signal priority levels can be configured based on the service agent in order to monitor signals based on both the monitor strategy and the signal priority level. For example, given a power-conserving monitor policy under a low-battery status or a hibernating status of a terminal device, signals of high priority levels are selected for monitoring. For another example, given a normal state monitor policy corresponding to a normal status or a being-charged status of a terminal device, all signals are to be monitored regardless of their respective priority levels. A monitor strategy can be configured to adjust the frequency at which the monitoring is conducted. For example, a power-conserving monitor strategy specifies a low frequency, such as once every five minutes, while a normal mode monitor strategy specifies a normal or an average frequency, such as once every minute. Accordingly, signals are monitored at the adjusted monitoring frequency.

According to various embodiments of the present disclosure, a monitor strategy can be configured in multiple ways. For example, it can be configured manually based on the needs of a user. Or, it can be configured as a monitor strategy issued by a server. Or, it can be configured based on the states of the system, which can be determined according to, for example, the types of a terminal device and/or the states of a terminal device. Again, terminal devices include, for example, mobile phones, tablets, wearable devices, in-vehicle devices, IoT devices, personal computers, desktop computer, and so on. Correspondingly, the types of a terminal device include at least one of the following: mobile phone, tablet, in-vehicle device, PC, IoT device, and other corresponding device types. Device state includes information such as, for example, the operational state of a terminal device. Device states include, for example, at least one of the following: operating mode and network-connectivity state.

In some embodiments, an operational state is determined based on both the operating mode and the network-connectivity state. Operating modes include, for example, at least one of the following: a normal mode, a being-charged mode, a power-saving mode, and a low-power mode, etc. Network-connectivity states include, for example, at least one of the following: a state of being connected to a Wi-Fi network, a state of being connected to a cellular network, and a state of being connected to a Bluetooth network, and the like. In general, a normal mode and a being-charged mode correspond to a normal operational state of a device. A power-saving mode and a low-power mode correspond to a power-saving operational state of a device. Further, different types of terminal devices tend to have different device states configured. For example, a mobile phone in a power-saving mode and connected to a cellular network is considered to be in a power-saving operational state; while an in-vehicle device in a power-saving mode and connected to a cellular network is still considered to be in a normal operational state. Therefore, specific states of a system are determined based both on the types or the platforms of a device, as well as the device states.

In some embodiments, system states (also referred to as profiles) comprise at least one of the following: a normal state, a low-power state, a hibernating state, and a power-saving state. A normal state designates a normal status of a terminal device, e.g., a mobile phone being in a normal mode with the battery level exceeding a threshold value. A low-power state designates a status in which the battery level of a terminal device is below a threshold value. A hibernating state designates a status in which a terminal device is hibernating. A power-saving state designates a status in which a terminal system is power conserving. A monitor strategy can be configured based on those system states such that signals are to be monitored according to different monitor strategies. In some embodiments, the system states information of a device is available at any time, serving as a basis to execute different monitor strategies for different performances and power controls.

For example, when a mobile phone is in a low-battery state, the monitoring of signals of less signal priority is stopped. When a mobile phone is in a deep sleep or a hibernating state, the frequency at which the signals are monitored is lowered. When a mobile phone is in power-saving mode, again, the monitoring of signals of less priority is stopped. In sum, the use of monitor strategies facilitates the smart control of the consumption of system resources such as power consumption.

After the one or more monitor strategies are determined and deployed, a service agent can be determined based on at least one signal monitored under the deployed monitor strategy. The service agent is utilized to determine the corresponding service instruction information subsequently. In particular, the monitored at least one signal is utilized to search to determine at least one corresponding service agent, which is further determined whether its service conditions are met. Once a service agent whose service conditions have been met is identified, such service agent is determined as the service agent to execute. Next, the service instruction information corresponding to the identified service agent is obtained and the service operations corresponding to the service instruction information are subsequently executed. Further details are described with reference to 358 through 362 in below.

At 358, the monitored at least one signal is utilized to search for a corresponding relationship involving the monitored signal such that to determine a service agent corresponding to the monitored signal.

As above-described, a system maintains a table or a configuration file registering corresponding relationships between service agents and signals. Therefore, once at least one signal is detected by monitoring a corresponding signal source, for example, Signal Provider component can be configured to use the detected at least one signal to search in the table or configuration file so that one or more service agents having a corresponding relationship with the detected signal are obtained accordingly. With an identified corresponding relationship with one or more service agents, the detected signal is matched to the corresponding one or more service agents.

At 360, it is determined whether the service conditions corresponding to the determined service agent are met.

In this example, Signal Provider component is configured to obtain the corresponding service conditions from the service agent and then to determine whether the service conditions have been met by the detected signals. In other words, by determining whether the service conditions of a service agent are met, the system determines whether a particular context occurs. Here, service conditions are determined according to specific contexts.

In some embodiments, a service condition is configured as a limiting condition on system relations and a relational expression can be used to indicate whether the transmitted signal data satisfies the service conditions configured for a service agent. For example, a combination of “AND” and “OR” is used to form a composite condition to determine whether a signal source generates or receives a signal meeting the service condition. Taking the aforementioned example of a service condition expressed as “A and (B or C)” (“A and B” or “A and C”), when the signal status of earphones is “plugged-in” (“A”), and the user motion signal is “running” (“B”) or “walking” (“C”), a corresponding context is determined as “user is running (or walking) with the earphones plugged in.” In other words, context detection can be conducted by a system service in the background on behalf of a context-aware application, without the context-aware application having to be launched during the entire process. In some embodiments, parameters corresponding to a signal can also be used to determine whether a service condition has been met, e.g., whether a service condition is determined as met can be determined based on whether a temperature value obtained from a signal has reached the threshold value of a temperature condition.

After the determination that the service conditions are met, the corresponding service agent is identified as the service agent to execute in order to respond to the context. In this case, process 350 continues onto 362. When it is determined that service conditions are not met, no service agent is identified as the service agent to execute, and process 350 goes back to 356 to continue to monitor for signals.

At 362, service instruction information is obtained from the service agent whose service conditions are met.

At 364, service operations corresponding to the service instruction information are executed.

In some embodiments, Actuator Provider component obtains service instruction information from the service agent identified for execution, e.g., the service agent whose service conditions are met. Service instruction information can be determined based on the service conditions that have been met, and service operations corresponding to the service instruction information are then executed accordingly. In some embodiments, service instruction information includes, for example, service identifying information and service operation information. Service identifying information is configured to identify the types of a service (or a service function). A service identifying information can correspond to, for example, service data such as the location at which the service is provided. Service operation information is configured to designate the operational information of a service (or a service function), such as the operations to be executed in response to the service conditions being met. Service instruction information further comprises, for example, service parameters. Service parameters are configured to designate the operational parameters, attribute information, etc. of a service (or a service function).

In some embodiments, the executing of the service operations corresponding to the service instruction information comprises obtaining service identifying information from the service instruction information, determining service operation information according to the service identifying information, and executing the service operations corresponding to the service operation information. Thus, service identifying (ID) information is obtained from the service instruction information such that the service operation information is determined based on the service ID information, and the corresponding service operations are executed based on the service operation information.

In some embodiments, the determination of service operation information based on the service identifying information, and the execution of service operations based on the service operation information comprise obtaining service identifying information from the service instruction information such as to acquire the data corresponding to the service identifying information, obtaining service operations from the service instruction information, executing the service operations corresponding to the service operation, obtaining service parameters from the service instruction information, and applying the data corresponding to the service parameters.

Service identifying information is obtained from the corresponding service instruction information, and data corresponding to the service identifying information is then obtained based on the service identifying information. For example, an actuator can be expressed in the form of “actuator://example.com/musiccard” to indicate a specific execution ID of a service, which is a playing music service in this example. Service operation information can be obtained from the service instruction information as well, and the operations corresponding to the service operation information are executed. For example, an action can be expressed in the form of “action://example.com/showcard” to indicate a specific action for providing the service, which is to display a music card in the example. Further, service parameters can be obtained from the service instruction information such that data corresponding to the service parameter can be applied. For example, a “params” can be expressed in the form of “page://example 2.com/favoritemusic” to indicate the specific parameter for executing the service, which is a playlist of a user's favorite songs in this example.

In some embodiments, whether or not to launch a context-aware application is determined based on the service operations corresponding to service instruction information. When the context-based service can be provided by executing the service operations in the background, it is no longer necessary to activate the context-aware application. However, when the service operations need to invoke a user interface of the application, the corresponding user interface is activated, with the detecting of the contexts and the logic processing of the contexts conducted still without the participation of the application.

Thus, through the use of system services in the background to detect contexts and to execute services in response to the contexts on behalf of a service, the consumption of system resources such as power can be controlled and conserved. In addition, by use of different monitor strategies and execution strategies customized to different operational environments and different device states, the aforementioned consumption of system resources can be smartly controlled and conserved.

In various embodiments of the present disclosure, terminal devices include various devices such as smart devices. For example, a terminal device can be configured with multimedia functionalities such as to support applications or services involving audio, video, and data, etc. A terminal device can also be configured to transmit or receive signals and to store or process signals, such as a lighting system. In some embodiments, a terminal device includes, for example, a smart phone, a tablet, a wearable device, a smart wearable device, or other smart mobile terminal devices. A terminal device can also include an IoT device or an in-vehicle device, such as a smart television, a smart router, a door security system, a lighting system, or household appliances such as a smart refrigerator, a smart oven, a smart rice cooker, or other smart kitchen appliances, etc. A terminal device can be configured with, for example, various operating systems and various smart operating systems, such as IOS, Android, and YunOS, etc.

In some embodiments, the present disclosure can be applied to the IoT technology. An IoT network, as an enormous network, aggregates a network (e.g., the Internet) with various information sensing devices (e.g., RFID devices, infrared sensors, global positioning (GPS) systems, and laser scanners, etc.) and service providing devices. One of the objectives of an IoT network is to achieve ubiquitous connectivity over all things with the Internet to facilitate identification and management thereof. In the age of ubiquitous connectivity, the types of user devices or terminal devices are becoming more and more diverse. For example, a user device or terminal device includes a device with a screen, a device without a screen, a household device, a wearable device, and so on. According to various embodiments of the present disclosure, an infrastructure of context engines is provided at the system level for the purposes of detecting contexts and providing services in response to the detected contexts. With this, various devices are inter-connected and various services are bundled to provide users with services in an active and automated manner.

With the afore-described processes for providing services, upon the detecting of signals, the corresponding service context is detected accordingly and the corresponding services are provided in response to the context. In particular, by use of a service architecture or service system model to monitor signals and to provide services in response to the signals, corresponding context can be detected for a user, and corresponding services are provided to the user automatically at the system level. Such systems include, for example, the IOS, Android, and YunOS system.

After service agents are developed, by use of applications and/or the operating system, automated context-aware services can be provided based on the afore-described infrastructure architecture. For example, a service agent is determined after a signal is received, and the service instruction information corresponding to the signal is accordingly determined as well. Further, the processing logic corresponding to the service instruction information is determined and the corresponding operations are executed.

FIG. 4A illustrates a schematic diagram of an example service providing system, in accordance with an embodiment of the present disclosure. System 400 can be configured to include context-detecting and processing devices (or platforms), such as mobile phones, tablets, wearable devices, other mobile devices, and the like. System 400 can also be configured to include IoT devices such as a smart refrigerator, a smart oven, a smart air-conditioning system, a smart lighting system, and the like. Therefore, with IoT devices connected to an IoT operating system, signals from IoT devices can be processed accordingly. Further, terminal devices such as mobile phones, tablets, etc. can be configured with connectivities to the IoT operating system or network such as to establish a connection with at least one IoT device on the system. Then, the operating system obtains the data adapters (not shown) for the contexts corresponding to the IoT devices. In some embodiments, data adapters are provided in the form of dynamic libraries, which are compiled or coded with the suitable data analyzing, converting, and processing functionalities. With the data adapters, signals are adapted for the execution of the logic processing. One data adapter can be configured to adapt to one or more signals. At such data adapters, signals can be registered, canceled, or subjected to logic processing, etc. Therefore, after an IoT device generates or obtains a signal, the signal is sent to a service platform such as an operating system. The corresponding service platform receives the signal, and uses a data adapter to analyze the signal. Accordingly, a context corresponding to the received signal is detected, and the corresponding service operations are executed to provide the user with the corresponding context-aware service. In particular, after the signal is processed at a data adapter, the processed signal is sent to an application or an operating system such that the application or the operating system can determine the corresponding service agent based on the signal, and subsequently execute the corresponding operations according to the service agent.

For example, a mobile phone operating system receives a temperature signal, which indicates that current temperature is over 30°. Based on this signal, a service agent, whose service conditions are met by the current temperature being over 30°, is determined. Next, based on the service instruction information obtained from the determined service agent, a home air-conditioning system is turned on. In another example, an operating system receives a security signal, which indicates that nobody is at home and the door is locked. Using this security signal, a lighting control agent is determined as the service agent to be executed. Next, the service instruction information is obtained from the lighting control agent, and the lights and air conditioner are turned off according to the determined service instruction information, preventing the home resources from being wasted.

In another example where devices correspond to an environment of an operating system, a context engine infrastructure and context-aware service development framework can be built at the system level. In particular, context detecting is provided at the system level, a reactive programming model can be provided on top of a dynamic language (e.g., JavaScript), and a universal protocol is used to interface various devices such as IoT devices.

FIG. 4B illustrates a block diagram of an example system model for providing services, in accordance with an embodiment of the present disclosure. System model 450 includes three modules: a Context Agent Host 452, a Context Agent Framework 454, and a Context Agent Engine 456. The relationships amongst these three modules are described in further details with reference to FIG. 5A. In general, Context Agent Engine 456 is configured to manage Context Agent Host 452, which relies on Context Agent Framework 454. In some embodiments, Context Agent Engine 456 is configured to receive one or more service agents transmitted from an application.

In particular, Context Agent Host 452, as used herein, refers to an application container capable of detecting contexts. As used herein, an application container is a class of objects that inherit from a base unit of applications (e.g., a base object class such as a Page object in reactiveX library of Javascript (RxJS)). A developer can use Context Agent Host 452 to program a context-aware application to be executed as an application in a system. As shown here in FIG. 4B, Context Agent Host 452 includes context-aware applications such as Context Agent A 4521, Context Agent B 4522, and Context Agent C 4523.

Context Agent Framework 454, as used herein, refers to a framework of applications utilizing context engines. It is through this framework that components at lower system levels are configured to provide components at upper system levels such as Context Agent Host 452 with the capability of context detecting and context-based service providing. In this example, Context Agent Framework 454 includes components of Signal Stream 4541, Subscription 4542, Actuator 4543, and Agent Instance 4544. Further details of these components are described below. Each of these components is configured to utilize a dynamic programming language such as Javascript supported by, for example, a reactiveX library of Javascript (RxJS), to handle the processing logic corresponding to a context.

Context Agent Engine 456, as used herein, refers to a system service of a context engine. It can be implemented as, for example, a stand-alone independent service embedded in (e.g., that is a part of) the system, responsible for managing context-aware applications such as Context Agent Host 452. In this example as shown herein, Context Agent Engine 456 includes components of Agent Management 4561, Execution Scheduling 4562, Security Gatekeeper 4563, Stream Management 4564, Subscription Management 4565, and Actuator Management 4566. Context Agent Engine 456 manages Context Agent Host 452 by using the aforementioned components, the details of which are illustrated with reference to FIGS. 5D-5E and 5G-5H.

FIG. 5A illustrates a relational block diagram of an example system model for providing service, in accordance with an embodiment of the present disclosure. As shown herein, Context Agent Host 5002, which includes instances of Context Agent A 5022 and Context Agent B 5024, depends from Context Agent Framework 5004 for inheritance of the Context Agent Framework's functionalities. Context Agent Host 5002 is also managed by Context Agent Engine 5006, the details of which are illustrated with reference to FIG. 5E.

FIG. 5B illustrates a block diagram of an example service providing application developed according to system model 450 of FIG. 4B, in accordance with an embodiment of the present disclosure. As shown, a context-aware application 5200 is developed using Javascript or other object-oriented language and comprises components of a Cloud App Package 5202, a Page 5204, a Page Link 5206, and an optional Page Cover 5208.

A developer builds context-aware applications derived from Context Agent Host 5201. Such a context-aware application can be presented in the form of, for example, a Cloud App Package 5202, which is an application package (e.g., a set of Javascript files that can be executed on its own) that performs operations under various contexts. In some embodiments, a Cloud App Package is identified by domain names.

Page 5204 is the unit (e.g., the base object class) of an application at the highest parent level. In other words, Page 5204 is the most base level application unit from which an application is derived. In this example, Context Agent Host 5201 inherits from Page 5204 the functionalities of detecting context and providing context-aware service. The Page represents a service component that has contextualized awareness and service capabilities.

Page Cover 5208 is a visualization component configured to provide the context-aware application with a user interface, which is configured to allow for interactions between a user and a device.

Page Link 5206 is a protocol for inter-app communication. Page Link 5206 can be used to invoke a context-aware application or to communicate with other applications. Page Link 5206 can be implemented using mechanisms such as the intents mechanism or the services mechanism.

In particular, after an application package is downloaded and installed locally on a terminal device, upon a context being detected, the context-aware application is launched to provide the corresponding services. Moreover, a user can control the context-aware services by engaging a human-machine interface provided by the package, for example, starting or stopping a context-aware service by clicking on a start button or a stop button, respectively.

FIG. 5C illustrates a schematic diagram of various components of an example Context Agent Framework of System 450 of FIG. 4B, in accordance with an embodiment of the present disclosure. As shown, Context Agent Framework 5300 comprises components of a Signal Stream 5302, a Subscription 5304, an Actuator 5306, and an Agent Instance 5308. The components can be implemented as objects using Javascript. In some embodiments, Context Agent Framework 5300 provides the upper layer (e.g., Context Agent Host or application 5200) with the capabilities to detect contexts and to provide context-based service.

Service agent or Agent as used herein refers to a logical unit corresponding to a complete context. Using a service agent or an agent, a context is detected and handled according to the processing logic corresponding to the context.

Agent Instance as used herein refers to an instance of an agent or a service agent instantiated for a particular environment and a particular device.

Signal Stream as used herein refers to a stream of signals received from sources such as I/O interfaces of various devices and systems. Through detecting various signals of the Signal Stream, applications at higher system layers are configured with the capabilities to detect a context. Also, Agent is configured to organize the logic for the detection of contexts by using Signal Stream.

Subscription as used herein refers to a subscription relationship mapping various signals to a context. A table, a configuration file, or the like can be used to maintain the corresponding relationships. It is through Subscription that signals correspond to contexts, which in turn correspond to context-based applications.

Actuator as used herein refers to a specific executable task of a context-aware service. It is the actual service to be performed when the system detects a context and thereby carries out correspondent logical processing of the context. For example, an Actuator can be tasked to, after detecting that the weather is hot and humid, turn on the air conditioning.

Context Agent Engine is configured to manage each context-aware application, including to maintain life cycles for each application.

FIG. 5D illustrates a state diagram of an example life cycle of a service providing application, in accordance with an embodiment of the present disclosure. An application goes through a life cycle comprising the states of Created, Running, Frozen, and Disposed.

Created 5402 is the state that an application has been created, indicating that the context-aware application at this state has already been installed on the user target device.

Running 5404 is the state of execution, during which an application performs operations according to the logic set forth by Agent.

Frozen 5406 is the state of frozen operations, during which an application no longer uses system resources, or provides any context-based services. In this state, the system resources previously reserved or used by the app can either be released in entirety, in part, or not at all. However, the application can be recovered or restored back to the running state 5404, in which the application continues to be executed by Context Agent Engine.

Disposed 5408 is the state of completion and conclusion of execution. The application process ends and all resources are released.

FIG. 5E illustrates a schematic diagram of example state transitions controlled by Context Agent Engine 456 of FIG. 4B, in accordance with an embodiment of the present disclosure. In this example, first, Context Agent Host 5502 is created by use of Context Agent Engine 5504 and Agent Control UI 5506. Later, Context Agent Engine 5504 can set Context Agent Host 5502 in a frozen state and later on restores the Context Agent Host 5502 into a running state. Context Agent Engine 5504 also controls Context Agent Host 5502 to conclude its execution, and correspondingly stops Dynamic Page Manager Service (DPMS) from servicing as well. In some embodiments, DPMS, generally implemented as a service process, is used as a management service for executing Page instances. Context Agent Engine 5504 can communicate the aforementioned control in the form of an event to Context Agent Host 5502 using inter-process communication mechanisms such as the intent mechanism, binders mechanism, Anonymous Shared Memory mechanism, or any suitable mechanisms for inter-process communication. DPMS is described in more detail below.

Next, an example of Page management based on YunOS™ (also referred to as Aliyun OS™), a mobile operating system, is described. The technique described is also applicable to other operating systems such as IOS, Android, etc.

(1) Page

Page as used herein refers to a service component that organizes local services and remote services in the form of a base unit of applications. By packaging different data and functions, a Page provides various kinds of services. In some embodiments, one context-aware service or application can include more than one Page. For example, a context-aware application can include one Page to provide a service of a UI (user interface), another for picture-taking, and/or another for a background service, such as user account authentication. A Page in execution is herein referred to as a Page instance. It is an execution entity for performing a local service or a remote service, and can be created by use of DPMS. For example, after receiving a Page Link to Page B sent by Page A, DPMS creates an instance of Page B. Page instances are also scheduled or managed by DPMS, which also maintains the life cycle of Page instances.

Each Page can be configured with a unique identifier in the YunOS. For example, a Page can be identified using a URI (Uniform Resource Identifier), which is generated by use of various suitable techniques that produce uniqueness in the identifiers. A URI functions as an address link to uniquely determine a corresponding Page. For example, to distinguish the services provided by Pages, pertinent information such as the title of a service, content of a service, delivery method of a service, provider of a service, etc. can be selectively embedded in the corresponding URIs and assigned to the Pages. In some embodiments, a Page is located at a server such as a cloud system via its respective URI, downloaded and installed onto a terminal device, and executed as an app.

Taking a calendar service provided by Company A for example, the URI assigned to the Page corresponding to the Company A's calendar service can be configured as:

Page://calendar.a.com

In the above, “Page://” is used to distinguish this address as the address corresponding to a Page and from addresses of other types such as a www site or an FTP site. “Calendar” indicates the title of the service provided at the Page, while “a” indicates the information about the service provider being company A.

Depending on the needs of a context, a Page may require the creation of multiple Page instances. To distinguish different instances of the same Page, a unique Page ID is further assigned to each Page instance for the purpose of identification. Such identifiers can be assigned when a Page instance is created. A Page instance is the executing state of a Page, i.e., the executing entity of a local or remote service. Again, the DPMS creates, schedules, and manages the life cycle of a Page instance. Likewise, a Page ID can be embedded in an information element (Page Link) and transmitted.

FIG. 5F illustrates a functional block diagram of an example interaction between Pages, in accordance with an embodiment of the present disclosure. In this example, Page A 5602 sends an event (e.g., included in a Page Link) to Page B 5604 and obtains data back from Page B 5604. Page A 5602 also interacts with a user 5606 through a UI 5608. Also as shown herein, Page A 5602 provides for Service A, and Page B 5604 provides for Service B. Page A 5602 provides to a user 5606 a display interface in the form of a UI 5608, through which Service A is displayed or delivered to the user 5606 and various inputs from the user 5606 are received. Further, Page B 5604 is configured to primarily run in the background and to provide service support for other Pages.

Further, a Page can be developed and destroyed and therefore has three states between being developed and destroyed.

Created is the state indicating that a Page has been created. After the Page is created (i.e., instantiated), it enters into the Created state.

Running is the state of execution after a Page is created. In this state, events and/or data are transmitted between Pages, and processed by respective receiving Pages.

Stopped is the state indicating that a Page is deactivated. In this state, a Page does not transmit events and/or data with other Pages.

FIG. 5G illustrates an example state switching of a Page, in accordance with an embodiment of the present disclosure. A Page is capable of switching between different states described above. Also, a life event notification is received at the time of switching to configure the Page's state after switching. DPMS controls Page state switching and life event notification.

As shown herein, when a Page (not shown) receives an onStart event 5703, the Page leaves Created state 5702 and enters Running state 5704. When the Page receives an onStop event 5705, the Page leaves Running state 5704 and enters Stopped state 5706. When in Running state 5704, the Page receives Page Links sent by the other Pages via the onLink interface 5707. The onStart event 5703 is the life event notification used to instruct the Page to begin entering Running state 5704. The onStop event 5705 is the life event notification used to instruct the Page to begin entering Stopped state 5706.

FIG. 5H illustrates another example state transitioning of a Page, in accordance with an embodiment of the present disclosure. For a Page having a UI (user interface), the running state can be in one of the following three sub-states:

Hidden is a sub-state when a page runs in the background and is not displayed to the user.

Shown-inactive (visibly non-interactive) is a sub-state when a page is displayed to the user in a mode that is not responsive to any user input.

Shown-active (visibly interactive) is a sub-state when a page is displayed to the user in a mode that is responsive to user inputs.

For example, Page A is displayed in a full-screen window; Page B is displayed in a partial-screen window. When Page B is displayed on top of Page A, Page A is in Shown-inactive sub-state, and Page B is in Shown-active sub-state.

Through life event notifications, a Page switches between different states and sub-states.

As shown here in FIG. 5H, after a Page (not shown) in Hidden sub-state 5802 receives an onShow event 5801, it enters Shown-inactive sub-state 5804. After a Page in Shown-inactive sub-state 5804 receives an onHide event 5803, it enters back to Hidden sub-state 5802. After a Page in Shown-inactive sub-state 5804 receives an onActive event 5805, it enters Shown-active sub-state 5806. After a Page in Shown-active sub-state 5806 receives an onInactive event 5807, it enters back to Shown-inactive sub-state 5804.

(2) PageLink

Page Link is an information element for transmission between Pages. Information such as, but not limited to, events, data, or the like are transmitted between Pages using Page Links. Such transmission of events and data can be implemented using a configured set of APIs (Application Programming Interfaces) according to inter-process and/or inter-thread communication protocols. Also by use of Page Links, YunOS records relationships between service components according to their communications. The URI of a target Page is configured in Page Link (e.g., stored in a configuration file), and information of events, data, and/or services can also be included in Page Link.

Pages, correlated through Page Links in a flexible manner, achieve the implementation of a variety of context-aware services.

(3) DPMS

DPMS (Dynamic Page Manager Service) as used herein refers to a system providing service component management entity. DPMS manages a Page's life cycle starting from the creation to the destruction. DPMS also manages Page's runtime scheduling, as well as inter-Page interactions via Page Links.

With the above-described service component management, a system is provided to include a service component management instance as well as N (N being an integer greater than 1) service components. Based on this system, the service component management component can be configured to receive an information entity sent by one service component directed at another service component, and to send the information entity to the second service component for processing.

With the above-described system, context-aware applications can be provided to a user according to the context.

Once Context Agents are developed, automated context-aware services based on the above-described system can be provided in accordance with embodiments of the present disclosure. In one embodiment, upon receiving a signal, a service agent is determined such that consequently service instruction information of the context-based service corresponding to the signal is determined. Next, the processing logic corresponding to the service instruction information is determined, and corresponding operations are executed at Context Agent Host to handle the context. For example, when it is detected that an oven has stopped heating (e.g., upon receiving an “oven stopped operating” signal), an alert context is detected such that the user is alerted with the message that the meal is temporarily not cooked and needs manual handling. After the user had finished manually handling the food and it is detected that the oven door is closed (e.g., upon receiving an “oven door shut” signal), another context is detected such that the oven is turned on again. In another example, once it is detected that the lights in the bedroom are turned on (e.g., upon receiving a “bedroom light turned on” signal), a bedroom-in-use context is detected and the lights in the foyer area etc. can be turned off to conserve electricity.

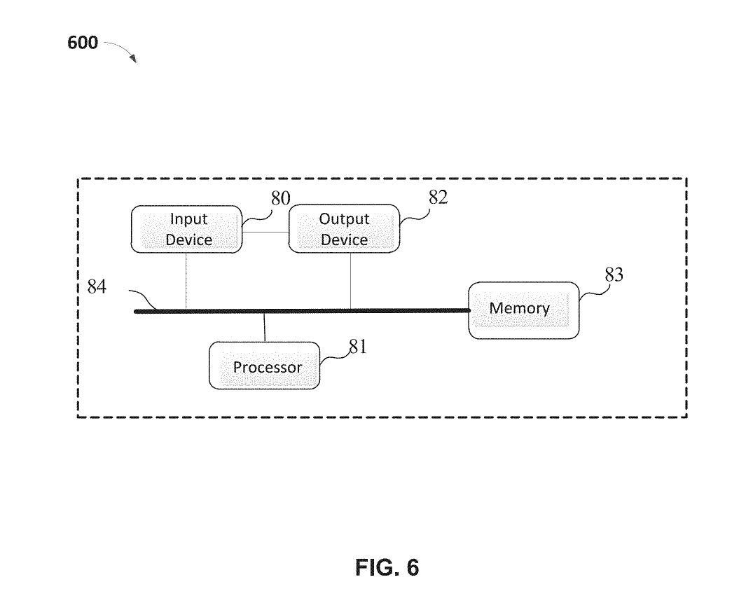

FIG. 6 illustrates a functional diagram of an embodiment of a terminal device for providing services, in accordance with an embodiment of the present disclosure. Device 600 can be a standalone device, an integrated in-vehicle sub-system of a vehicle (e.g., an automobile, an aircraft, a ship, etc.), or a standalone in-vehicle system. Device 600 can be used to implement processes and systems of FIGS. 1-5, as appropriate. As will be apparent, other device architectures and configurations can be used to implement the systems and methods for providing services. Device 600 includes a processor 81, an output device 82, an input device 80, memory 83, and at least one communication bus 84.

Communication bus 84 is for implementing inter-component communication connections. Memory 83 may contain high-speed RAM memory, or non-volatile memory (NVM), such as at least one magnetic disk storage device. Memory 83 stores various programs used to instruct various processes to be executed by computing device 600.

Optionally, processor 81 can be implemented as a central processing unit (CPU), an application-specific integrated circuit (ASIC), a digital signal processor (DSP), a digital signal processing device (DSPD), a programmable logic device (PLD), a field-programmable gate array (FPGA), a controller, a microcontroller, a microprocessor, or another electronic component. Processor 81 is configured to couple to input device 80 and output device 82 through a wired or wireless connection.

Optionally, device 600 may comprise multiple input devices. For example, it could comprise at least one of the following: a user-oriented user interface, a device-oriented device interface, a software programmable interface, a camera, a sensor, a transceiver, and the like. Optionally, the device-oriented device interface may be a wired interface for conducting device-to-device data transmissions, a hardware connection interface (e.g., a USB interface or a serial port) for conducting device-to-device data transmissions, or the like. Optionally, the user-oriented user interface could, for example, be user-oriented control keys, a speech input device for receiving speech input, or a touchscreen perceiving device (such as a touchscreen or a touch tablet having touch-sensing functions). Optionally, the programmable interface of the software described above could be a portal, such as a chip input pin interface or output interface, through which the user edits or modifies the program. Optionally, the transceiver described above could be a radio-frequency transceiver chip, a baseband chip, or a transceiver antenna. A microphone or other audio input device can receive speech data. Output device 82 may include a display device, sound equipment, and other output devices.

In some embodiments, processor 81 of the terminal device 600 comprises functions for executing all modules in the data-processing means in each device. For specific functions and technical results, refer to the embodiments described above. They will not be discussed further here.

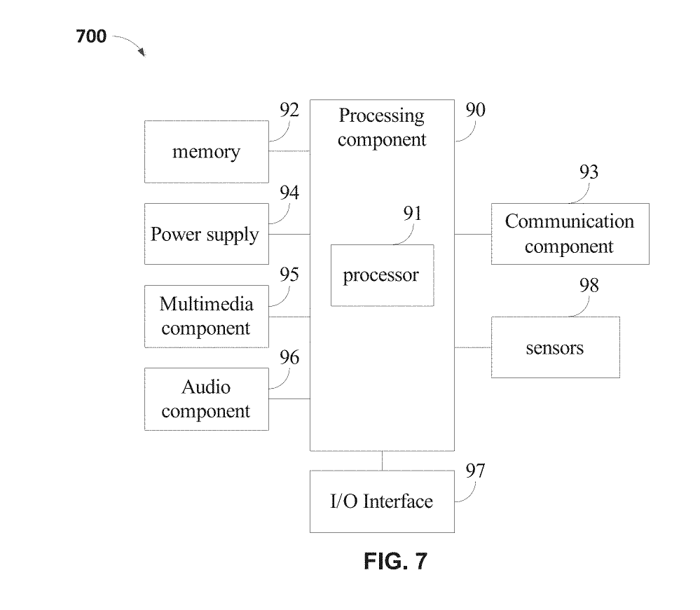

FIG. 7 illustrates a functional block diagram of an embodiment of a programmed computer system for providing services, in accordance with an embodiment of the present disclosure. Computing system 700 can be used to implement the systems and processes of FIGS. 1-5H, as appropriate. As will be apparent, other computer system architectures and configurations can be used to implement the systems and methods for providing services. Computing system 700, which includes various subsystems as described below, includes a processor 91 and a memory 92. Processor 91 executes the computer code stored in memory 92 to implement the above-described processes and systems of FIGS. 1-5H. For example, processor 91 can be implemented by a single-chip processor or by multiple processors. In some embodiments, processor 91 is a general purpose digital processor that controls the operation of the computer system 700. Using instructions retrieved from memory 92, processor 91 controls the reception and manipulation of input data, and the output and display of data on output devices (e.g., display). In particular, Processor 91 is coupled bi-directionally with memory 92, which can include a first primary storage area, typically a random access memory (RAM), and a second primary storage area, typically a read-only memory (ROM). Primary storage can be used as a general storage area and as scratch-pad memory, and can also be used to store input data and processed data. Primary storage can also store programming instructions and data, in the form of data objects and text objects, in addition to other data and instructions for processes operating on processor 91. Primary storage typically includes basic operating instructions, program code, data, and objects used by the processor 91 to perform its functions (e.g., programmed instructions). For example, memory 92 can include any suitable computer readable storage media, described below, depending on whether, for example, data access needs to be bi-directional or uni-directional. For example, processor 91 can also directly and very rapidly retrieve and store frequently needed data in a cache memory (not shown). Memory 92 can also be configured to store data such as messages, pictures, and video, etc.

Optionally, processor 91 is set up in a processing component. Computing system 700 may further comprise: a communication component 93, a power supply component 94, a multimedia component 95, an audio component 96, an I/O interface 97, and/or a sensor component 98. The components specifically contained within computing system 700 are set according to need. The present embodiment imposes no limitations with regard to them.

Processing component 90 generally controls the overall operations of the terminal device. Processing component 90 can comprise one or more processors 91 for executing instructions so as to complete all or some of the steps of the method described above with regard to FIGS. 1 through 5H. In addition, processing component 90 may comprise one or more modules to facilitate interaction between processing component 90 and other components. For example, processing component 90 may comprise a multimedia module to facilitate interaction between multimedia component 95 and the processing component 90.

Power supply component 94 provides power to the various components of computing system 700. Power supply 94 can include a power supply management system, one or more power supplies, and other components related to generating, managing, and allocating power to the terminal device.

Multimedia component 95 comprises an output interface display screen provided between computing system 700 and the user. In some embodiments, the display screen may comprise a liquid crystal display (LCD) or a touch panel (TP). If the display screen comprises a touch panel, the display screen may be implemented as a touchscreen to receive input signals from the user. The touch panel comprises one or more touch sensors to detect touches, sliding actions, and gestures on the touch panel. Said touch sensor can not only detect the boundaries of touch or slide actions, but also can measure duration and pressure related to said touch or slide operations.

Audio component 96 is configured to output and/or input audio signals. For example, the audio component 96 includes a microphone (MIC). When computing system 700 is in an operating mode, e.g., speech recognition mode, the microphone is configured to receive external audio signals. The received audio signals can be further stored in storage device 92 or sent by communication component 93. In some embodiments, the audio component 96 further comprises a speaker for output of audio signals.

I/O interface 97 provides an interface between processing component 90 and peripheral interface modules. The aforesaid peripheral interface modules may be keyboards, click wheels, buttons, wireless mouse, etc. These buttons may include but are not limited to: volume button, start button, and lock button.

Sensor component 98 comprises one or more sensors and is used to provide status evaluations of various aspects of computing system 700. For example, sensor component 98 may detect the on/off status of computing system 700, the relative position of the component, and the presence or absence of contact between the user and computing system 700. Sensor component 98 may comprise a near sensor that is configured to detect the presence of a nearby object when there is no physical contact, including measurement of distance between the user and computing system 700. In some embodiments, sensor component 98 may further comprise a camera.

Communication component 93 is configured to facilitate wired or wireless communication between computing system 700 and other devices. Computing system 700 may access wireless networks based on a communications standard such as Wi-Fi, 2G, 3G, 4G, 5G or combinations thereof. In an embodiment, computing system 700 may comprise a SIM card slot. The SIM card slot is for inserting a SIM card, which enables computing system 700 to register with a GPRS network and establish communication between the Internet and servers.

In some embodiments, communication component 93, audio component 96, I/O interface 97, and sensor component 98 of FIG. 7 may implement input device 80 in FIG. 6.

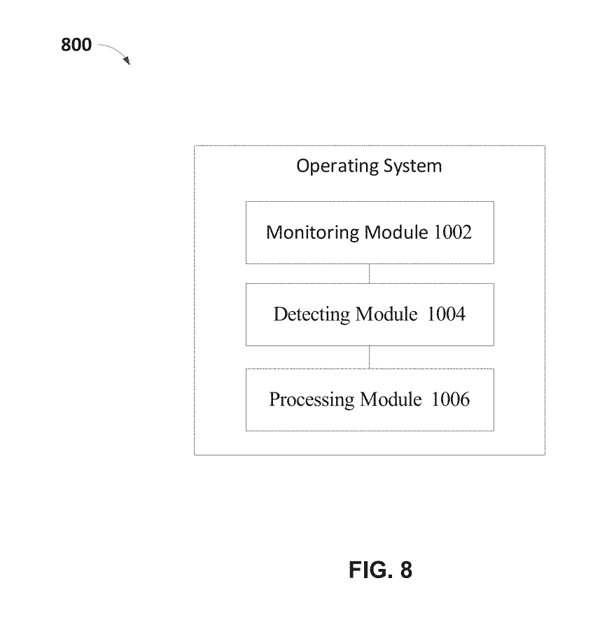

FIG. 8 illustrates a block diagram illustrating an example operating system for providing services, in accordance with embodiments of the present disclosure. Operating system 800 comprises a monitor module 1002, a detection module 1004, and a processing module 1006. Monitor module 1002 is configured to monitor one or more signals. Detecting module 1004 is configured to determine a service agent based on at least one monitored signal and to determine the service instruction information corresponding to the determined service agent, the determined service agent corresponding to an application. Processing module 1006 is configured to execute one or more operations corresponding to the determined service instruction information.

In some embodiments, operating system 800 further comprises a service providing a context agent framework, which is configured to determine service instruction information based on the obtained signals. Operating system 800 further comprises an agent engine, which is configured to execute context-based services corresponding to the service instruction information, the context-based services including at least one unit of service. Operating system 800 further comprises an agent host, which is configured to execute the operations corresponding to the context-based services.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for providing services, comprising:
monitoring one or more signals that are generated by a device or received at the device;
determining a service agent based at least in part on at least one monitored signal, wherein the service agent corresponds to an application and is configured to detect and execute one or more services associated with the application;
determining service instruction information corresponding to the determined service agent; and
executing one or more operations corresponding to the determined service instruction information.

2. The method of claim 1, wherein at least one monitored signal specifies a context, and the determination of the service agent is based at least in part on the context.

3. The method of claim 1, wherein the application corresponds to a plurality of service agents.

4. The method of claim 1, wherein the monitoring of the one or more signals comprises monitoring one or more signal sources to obtain the at least one monitored signal.

5. The method of claim 1, wherein the determining of the service agent based on the at least one monitored signal and the determining of the service instruction information corresponding to the service agent comprises:
searching a database storing mapping relationships between service agents and signals to determine at least one service agent based in part on the at least one monitored signal;
determining the service agent whose one or more conditions are met; and
obtaining the service instruction information corresponding to the determined service agent.

6. The method of claim 5, wherein the determining of the service agent whose one or more conditions are met and the obtaining of the service instruction information corresponding to the service agent comprises:
determining, based on the at least one monitored signal, whether the one or more conditions of the service agent are met; and
in response to the one or more conditions of the service agent being met, obtaining the service instruction information from the service agent.

7. The method of claim 1, wherein the service instruction information comprises service identifying information and service operation information.

8. The method of claim 7, wherein the executing of the one or more operations corresponding to the service instruction information comprises:
obtaining the service identifying information from the service instruction information;
determining the service operation information based in part on the service identifying information; and
executing operations corresponding to the service operation information.

9. The method of claim 8, wherein the service instruction information further comprises service parameters, and the determining of the service operation information based in part on the service identifying information and the executing of the operations corresponding to the service operation information comprises:
determining the service operation information and the service parameters based in part on the service identifying information; and
executing the operations corresponding to the service operation information according to the service parameters.

10. The method of claim 1, wherein the service instruction information comprises service identifying information, service operation information, and service parameters; and the
executing of the operations corresponding to the service instruction information comprises at least one of:
obtaining the service identifying information based in part on the service instruction information to obtain data corresponding to the service identifying information;
obtaining the service operation information based in part on the service instruction information to execute the operations corresponding to the service operation information; and
obtaining the service parameters based in part on the service instruction information to apply data corresponding to the service parameters.

11. The method of claim 1, wherein the determining of the service agent comprises:
receiving the service agent transmitted from the application; and
establishing at least one corresponding relationship between the service agent and at least one signal.

12. The method of claim 11, wherein the establishing of the at least one corresponding relationship between the service agent and the at least one signal comprises:
obtaining a required signal from the service agent; and
recording the corresponding relationship between the required signal and the service agent.

13. The method of claim 1, wherein the monitoring of the one or more signals comprises monitoring the one or more signals according to a monitor strategy.

14. The method of claim 13, wherein the monitor strategy is determined based in part on system state information.

15. The method of claim 13, wherein the monitoring of the one or more signals according to the monitor strategy comprises at least one of:
selecting, based in part on the monitor strategy and a signal priority level, the one or more signals to monitor; and
adjusting a monitoring frequency based in part on the monitor strategy such that the monitoring of the one or more signals is based on the adjusted monitoring frequency.

16. The method of claim 14, wherein the system state information is determined based in part on a device type and/or a device status.

17. The method of claim 14, wherein the system state information comprises at least one of: a normal state, a low-power state, a hibernating state, and a power-saving state.

18. The method of claim 16, wherein the device type comprises at least one of: a mobile phone type, a tablet type, an in-vehicle type, a Personal Computer type, and an Internet of Things object type; and wherein the device status comprises at least one of: an operating mode and network-connectivity state.

19. A method for providing services, comprising:
obtaining a service agent associated with an application based at least in part on one or more detected signals associated with a system on which the application executes;
transmitting the service agent to an operating system;
determining service instruction information based in part on the transmitted service agent; and
executing operations corresponding to the service instruction information.

20. The method of claim 19, wherein the application corresponds to one or more service agents.

21. The method of claim 19, wherein the service agent is configured to detect a context and to execute one or more services of the application.

22. The method of claim 19, wherein the service agent comprises signals, service instruction information, and service conditions, and the service agent is configured to execute operations corresponding to the service instruction information upon receiving the one or more signals and determining that the service conditions are met.

23. The method of claim 22, wherein the service instruction information comprises service identifying information and service operation information, the service identifying information used to determine data to be obtained, and the service operation information used to determine operations to be executed.

24. The method of claim 23, wherein the service instruction information further comprises one or more service parameters, the one or more service parameters used to determine data to be applied.

25. A device for providing services, comprising:
one or more processors configured to:
monitor one or more signals that are generated by a device or received at the device;
determine a service agent based on at least one monitored signal, wherein the service agent corresponds to an application and is configured to detect and execute one or more services associated with the application;
determine service instruction information corresponding to the determined service agent; and
execute one or more operations corresponding to the determined service instruction information; and
one or more memories coupled to the one or more processors and configured to provide the one or more processors with instructions.

26. The device of claim 25, wherein at least one monitored signal specifies a context, and the determination of the service agent is based at least in part on the context.

27. The device of claim 25, wherein the application corresponds to a plurality of service agents, and the service agent is configured to detect and execute one or more services of the application.

28. The device of claim 25, wherein the one or more processors are further configured to monitor one or more signal sources to obtain the at least one monitored signal.

29. The device of claim 25, wherein the one or more processors are further configured to:
search a database storing mapping relationships between service agents and signals to determine at least one service agent based in part on the at least one monitored signal;
determine the service agent whose one or more conditions are met; and
obtain the service instruction information corresponding to the determined service agent.

30. The device of claim 25, wherein the service instruction information comprises service identifying information and service operation information, and the one or more processors are further configured to:
obtain the service identifying information from the service instruction information;
determine the service operation information according to the service identifying information; and
execute operations corresponding to the service operation information.

31. The device of claim 25, wherein the service instruction information comprises service identifying information, service operation information, and service parameters; and the one or more processors are further configured to:
obtain the service identifying information based in part on the service instruction information to obtain data corresponding to the service identifying information;
obtain the service operation information based in part on the service instruction information to execute the operations corresponding to the service operation information; and
obtain the service parameters based in part on the service instruction information to apply data corresponding to the service parameters.

32. The device of claim 25, wherein the one or more processors are further configured to:
receive a service agent transmitted by the application; and
establish one or more corresponding relationships between the service agent and at least one signal.

33. The device of claim 25, wherein the one or more processors are further configured to:
monitor the one or more signals according to a monitoring strategy, the monitoring strategy determined based in part on system state information.

34. A device for providing services, comprising:
one or more processors configured to:
obtain a service agent associated with an application based at least in part on one or more detected signals associated with a system on which the application executes;
transmit the service agent to an operating system;
determine service instruction information based in part on the transmitted service agent, the service instruction information corresponding to the one or more detected signals; and
execute operations corresponding to the service instruction information; and
one or more memories coupled to the one or more processors and configured to provide the one or more processors with instructions.

35. The device of claim 34, wherein the application corresponds to a plurality of service agents, and the plurality of service agents is configured to detect and to execute one or more services of the application.

36. The device of claim 34, wherein:
the service agent comprises one or more signals, service instruction information and service conditions;
the service agent is configured to, upon receiving the one or more signals and determining that the service conditions are met, execute the operations corresponding to the service instruction information; and
the service instruction information comprises service identifying information and service operation information, the service identifying information is used to determine data to be acquired, and the service operation information is used to determine operations to be executed.

37. A computer program product for applications, the computer program product being embodied in a tangible non-transitory computer readable storage medium and comprising computer instructions for:
monitoring one or more signals that are generated by a device or received at the device;
determining a service agent based on at least one monitored signal, wherein the service agent corresponds to an application and is configured to detect and execute one or more services associated with the application;
determining service instruction information corresponding to the determined service agent; and
executing one or more operations corresponding to the determined service instruction information.

38. A computer program product for applications, the computer program product being embodied in a tangible non-transitory computer readable storage medium and comprising computer instructions for:
obtaining a service agent associated with an application based at least in part on one or more detected signals associated with a system on which the application executes;
transmitting the service agent to an operating system;
determining service instruction information based in part on the transmitted service agent; and
executing operations corresponding to the service instruction information.
